(19) United States
(12) Patent Application Publication
(10) Pub. No.: US 2024/0376622 A1
(43) Pub. Date: Nov. 14, 2024

(54) SILVER RECOVERY FROM END-OF-LIFE SILICON SOLAR PANELS

(71) Applicant: University of Kentucky Research Foundation, Lexington, KY (US)

(72) Inventors: Xin Gao, Lexington, KY (US); Min Xiao, Lexington, KY (US); Kunlei Liu, Lexington, KY (US); Aron Patrick, Lexington, KY (US)

(21) Appl. No.: 18/659,851

(22) Filed: May 9, 2024

Related U.S. Application Data
(60) Provisional application No. 63/465,492, filed on May 10, 2023.

(51) Int. Cl. C25C 1/20; C25C 1/12; C25C 7/02; C25C 7/06

(52) U.S. Cl. CPC C25C 1/20; C25C 1/12; C25C 7/02; C25C 7/06

(57) ABSTRACT

A method of recycling solar panels, including a frame, glass, silicon wafers, and wiring, incorporates the steps of: (a) delaminating the solar panel by breaking down ethylene-vinyl acetate polymer in the solar panel to generate fumed acetic acid, (b) dissolving silver from the silicon wafers of the solar panel in a metal recovery solution using the fumed acetic acid generated during the delaminating and (c) recovering the dissolved silver from the metal recovery solution.

### RELATED APPLICATION

This patent application claims the benefit of U.S. Provisional Patent Application Ser. No. 63/465,492, filed on May 10, 2023, the full disclosure of which is incorporated herein by reference.

### TECHNICAL FIELD

This document relates generally to the recycling field and, more particularly, to the recycling of silicon solar panels and the recovery of valuable metals, such as silver, from those solar panels.

### BACKGROUND

State-of-the-art recovery of silver from recycling materials involves: (a) treating those materials with nitric acid to dissolve the silver into a metal recovery solution, (b) adding excessive chloride salts to produce silver chloride which has low water solubility and precipitates from the metal recovery solution, (c) filtering the silver chloride from the metal recovery solution and (d) recovering the silver from the silver chloride. Unfortunately, the use of relatively harsh nitric acid and excessive chlorides leads to significant environmental concerns. While these may be cleaned from the metal recovery solution using ion exchange resins, the excessive nitrates (NO₃⁻) and chlorides (Cl⁻) substantially shorten the useful life of the relatively expensive ion exchange resins adding significantly to processing costs.

In view of the above concerns, a need is identified for new and improved methods for silver recovery from recycling materials, including, particularly silicon solar panels. This document relates to just such a method wherein (a) the silver is dissolved with acetic acid generated from the thermal decomposition of the ethylene-vinyl acetate polymer in the solar panels and (b) there is no need to outsource any acids such as nitric acid.

### SUMMARY

In accordance with the purposes and benefits set forth herein, a new and improved method is provided for the recycling of solar panels, including a frame, glass, silicon wafers, and wiring. The method comprises, consists of or consists essentially of the steps of: (a) delaminating the solar panel by breaking down ethylene-vinyl acetate polymer in the solar panel to generate fumed acetic acid, (b) dissolving silver from the silicon wafers of the solar panel in a metal recovery solution using the fumed acetic acid generated during the delaminating, and (c) recovering the dissolved silver from the metal recovery solution.

The method may further include adding hydrogen peroxide to the fumed acetic acid to catalyze the dissolving of the silver. In at least some embodiments, the method further includes using about 25 wt % to about 75 wt % acetic acid mixed with about 15 wt % hydrogen peroxide to selectively dissolve the silver in the silicon wafers.

In at least some embodiments, the recovering of the silver includes electrowinning the silver. The electrowinning of the silver may include passing the metal recovery solution through an electrowinning cell including an anode and a cathode. Still further, the method may include applying a voltage of between about 0.7 volts and about 1.2 volts across the anode and the cathode to deposit the silver from the metal recovery solution at the cathode.

Still further, the method may include electrowinning copper from the metal recovery solution after electrowinning the silver. The electrowinning of the copper may include applying a voltage of about 1.2 volts and about 2.0 volts across the anode and the cathode to deposit copper from the metal recovery solution at the cathode. In at least some embodiments, the method includes changing the cathode before the electrowinning of the copper.

Consistent with the above disclosure, the method may include using carbon electrodes for the anode and the cathode. The method could also include subjecting the metal recovery solution to ion exchange filtration and pH adjustment before discharge into the environment.

In the following description, there are shown and described several different embodiments of the new and improved method of recycling solar panels. As it should be realized, the method is capable of other, different embodiments and its several details are capable of modification in various, obvious aspects all without departing from the method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the method and together with the description serve to explain certain principles thereof. A person of ordinary skill in the art will readily recognize from the following discussion that alternative embodiments of the method may be employed without departing from the principles described below.

FIG. 1 is an exploded perspective view of a silicon based solar cell.

FIG. 2 is a schematic block diagram of the new and improved method for the recycling of silicon solar panels and the recovery of valuable metals from those solar panels including silver.

Reference will now be made in detail to the present preferred embodiments of the method.

### DETAILED DESCRIPTION

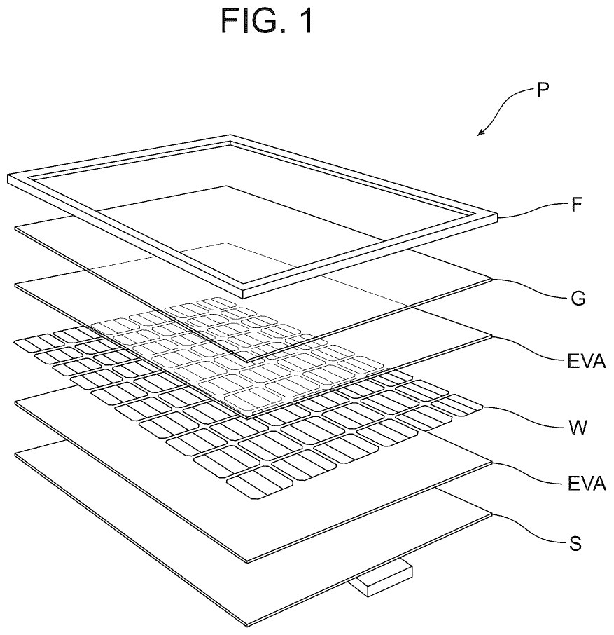

Reference is now made to FIG. 1 which illustrates a state-of-the-art silicon solar cell or panel P. The silicon solar panel P includes a plurality of silicon wafers W that generate electricity when subjected to sun light. The silicon wafers W, which include silver, are (a) interconnected by fingers and busbars B that are typically made of copper and (b) supported on a polymer backing sheet S. A high-transparency tempered glass G covers the silicon wafers W. Two layers of ethylene-vinyl acetate polymer EVA, that is, one layer between the polymer backing sheet P and the silicon wafers W and another layer between the silicon wafers and the glass G, scal the solar panel against dust and moisture intrusion.

State-of-the-art solar panels P of the type illustrated in FIG. 1, have a limited useful life. At the end of that useful life, such solar panels P should be recycled to recover valuable metals such as the silver on the silicon wafers W and the copper in the fingers, busbars and associated wiring B. The aluminum used to make the frame and the glass cover may also be recycled.

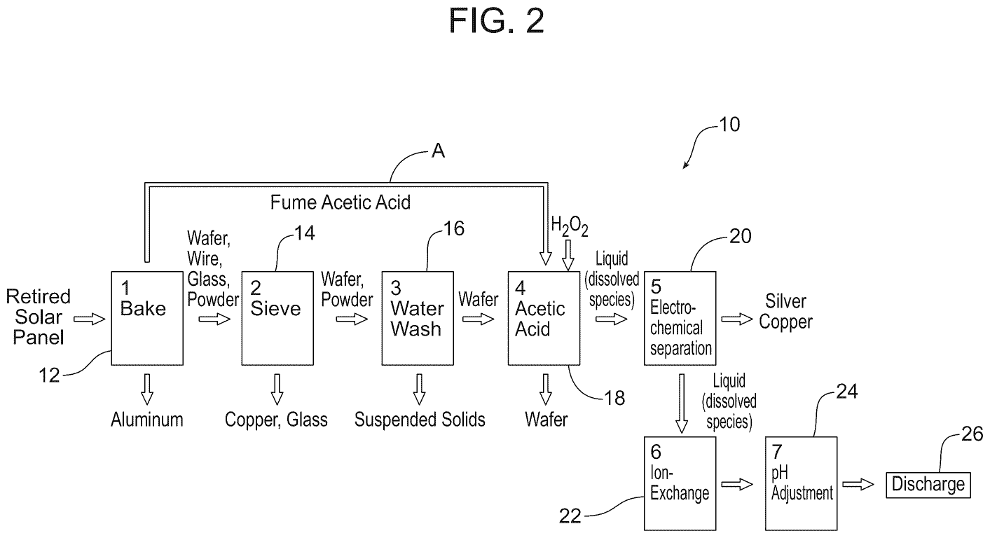

The new and improved method 10 of recycling solar panels P, may be broadly described as including the steps of: (a) delaminating the solar panel by breaking down ethylene-vinyl acetate polymer EVA in the solar panel to generate fumed acetic acid, (b) dissolving silver from the silicon wafers of the solar panel in a metal recovery solution using the fumed acetic acid generated during the delaminating, and (c) recovering the dissolved silver from the metal recovery solution. See FIG. 2.

The delaminating step includes baking the solar panel P at a temperature of about 300° C. to about 600° C. under nitrogen or air for about 1 hour to about 5 hours in order to (a) degrade the ethylene-vinyl acetate polymer EVA in the solar panel and (b) generate fumed acetic acid (see Box 12 and note action arrow A). This debonds the ethylene-vinyl acetate polymer EVA, thereby allowing the components of the solar panel P, including the aluminum frame F, glass cover G, the silicon wafers W and the fingers, busbars and associated wiring B, to be separated for subsequent processing and recovery. The fumed acetic acid generated during the baking/delaminating step is captured by either water of alkaline solution scrubbing in a manner known in the art. The separating or sorting of the components noted above may be completed by sifting or sieving based upon size and shape exclusion (see Box 14) also in a manner known in the art.

Next is the processing of the separated silicon wafers W to recover valuable silver and copper. Before initiating the chemical process for silver recovery, the surfaces of the silicon wafers W are washed with water to remove suspended solids, such as fine glass particles (see Box 16). Next is the dissolving of the silver in the silicon wafers W. This is accomplished by treating the silicon wafers W with the fuming acetic acid, recovered during the baking step (Box 12), mixed with a catalyzing agent. More particularly, hydrogen peroxide is added to the fumed acetic acid. In one particularly useful embodiment, about 50 wt % acetic acid is mixed with about 15 wt % hydrogen peroxide to selectively dissolve into a metal recovery solution, the silver in the silicon wafers W (see Box 18).

Next is the recovering of the dissolved silver from the metal recovery solution by electrowinning. Toward this end, the metal recovery solution with the dissolved silver is filtered to remove solids and then passed through an electrowinning cell including an anode and a cathode. In one particularly useful embodiment, the anode and cathode are both made of carbon. A voltage of between about 0.7 volts and about 1.2 volts is applied across the anode and the cathode to deposit the silver from the metal recovery solution at the cathode. See Box 20.

This may then be followed by electrowinning copper from the metal recovery solution. Toward this end, the cathode may be changed, to remove the original and now silver coated cathode. A voltage of about 1.2 volts and about 2.0 volts is then applied across the anode and the cathode to deposit copper from the metal recovery solution at the changed cathode. Again, see Box 20.

Following electrowinning of the silver and then the copper, the metal recovery solution is subjected to (a) ion exchange to remove any acetate ions and remaining trace heavy metals (see Box 22) and (b) pH adjustment to approximately 7 by the addition of, for example, carbonate or bicarbonate before discharge into the environment (see Boxes 24 and 26).

### EXPERIMENTAL SECTION

The delamination or baking process was performed at 600° C. for 3 hours using a box furnace opened to air. It is found that the EVA polymers between the glass and silicon wafer layers were degraded under such a testing condition via

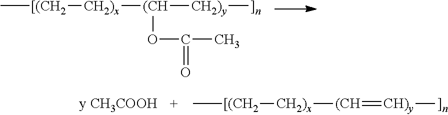

consequently, causing the solar panel being dismantled to copper wires, silicon wafers, glass particles, and aluminum frame. The remaining solids were separated by sieve grids with different shapes and sizes, yielding copper wires, silicon wafers, and glass particles. The silicon wafers were further used to demonstrate the recovery of silver after the silicon wafers were cleaned by water.

Silver and Aluminum Removal for Acetic Acid versus Nitric Acid—In this test, 35 wt % nitric acid and 50 wt % acetic acid mixed with 15 wt % hydrogen peroxide were used to dissolve the silver printed on the surface of silicon wafer for about 24 hours without agitation. The mass ratio

| Case | Ag/ppm | Al/ppm | Cu/ppm |
|---|---|---|---|
| 35 wt % HNO₃ | 57.1 | 45.1 | 65.3 |
| 50 wt % Acetic Acid 15 wt % H₂O₂ | 57.2 | 13.1 | 18.1 |

of acid to solids is 1:1. A visual contrast of removing silver, suggests that acetic acid mixed with hydrogen peroxide can dissolve silver, resulting in a very close effectiveness when using nitric acid. Mechanisms of dissolving silver by nitric acid are 3Ag+4HNO₃=3AgNO₃+NO+2H₂O and/or Ag+2HNO₃=AgNO₃+NO₂+H₂O. Mechanisms of dissolving silver by acetic acid with hydrogen peroxide are H₂O₂+CH₃CO₂H=CH₃CO₃H+H₂O, in which CH₃CO₃H is an oxidant that is capable of dissolving metallic silver from the surface of a silicon wafer. However, the aluminum layer at the back of silicon wafer was not able to be dissolved when using the acetic acid mixed with hydrogen peroxide. Such an observation is validated by examining the speciation in the liquids by ICP-OES. It is found that concentrations of dissolved aluminum and copper after the nitric acid treatment are much greater than those associated with acetic acid mixed with hydrogen peroxide. In contrast, concentrations of silver from two cases are within analytic uncertainty. Overall, it is believed that the case of 50 wt % acetic acid mixed with 15 wt % H₂O₂ can selectively dissolve silver among the other metals such as aluminum and copper.

Use of Acid Collected from Delamination to Dissolve Silver—The fumed acetic acid during the EVA polymer degradation was adsorbed by water using a tube furnace and an ice-water bath. In this test, about 130 g of crushed solar panel was placed in the furnace and treated at 500° C. for 1 hour under 1.5 L min⁻¹ N₂. After the test, pH of the liquid was reduced to about 2 from 6.5. The acid was mixed with 15 wt % hydrogen peroxide followed by removing silver from the surface of silicon wafers. Silver was removed at the front side of silicon wafer, but aluminum was retained at the back side of the silicon wafer (i.e., silver was dissolved and aluminum was retained, when lab-grade acetic acids were used).

Electrochemical Silver Deposition—After the silver was dissolved, the filtered liquid was poured into the solution tank of the electro-winning system. By setting a constant voltage at 0.7-1.2 V across the electrochemical flow cell, silver can be effectively deposited onto the carbon fiber electrode surface at the liquid flowrate of 50 mL min⁻¹. X-ray technique confirms that the metallic silver was deposited onto the carbon fiber. To recover copper, a higher operating voltage, i.e., 1.2-2 V is required. Finally, along with a proper neutralization, a small number of heavy metals in the liquid will be managed by ion-exchange before discharge.

This disclosure may be said to relate to the following items.
1. A method of recycling solar panels, including silicon wafers, comprising:
   delaminating the solar panel by breaking down ethylene-vinyl acetate polymer in the solar panel to generate fumed acetic acid;
   dissolving silver from the silicon wafers of the solar panel in a metal recovery solution using the fumed acetic acid generated during the delaminating; and
   recovering the dissolved silver from the metal recovery solution.
2. The method of item 1, further including adding hydrogen peroxide to the fumed acetic acid to catalyze the dissolving of the silver.
3. The method of item 2, including using about 25 wt % to about 75 wt % acetic acid mixed with about 15 wt % hydrogen peroxide to selectively dissolve the silver in the silicon wafers.
4. The method of item 3, wherein the recovering of the silver includes electrowinning the silver.
5. The method of item 4, wherein the electrowinning of the silver includes passing the metal recovery solution through an electrowinning cell including an anode and a cathode.
6. The method of item 5, including applying a voltage of between about 0.7 volts and about 1.2 volts across the anode and the cathode to deposit the silver from the metal recovery solution at the cathode.
7. The method of item 6, including electrowinning copper from the metal recovery solution after electrowinning the silver.
8. The method of item 7, wherein the electrowinning of the copper includes applying a voltage of about 1.2 volts and about 2.0 volts across the anode and the cathode to deposit copper from the metal recovery solution at the cathode.
9. The method of item 7, including changing the cathode before the electrowinning of the copper.
10. The method of item 9, including using carbon electrodes for the anode and the cathode.
11. The method of item 5, including using carbon electrodes for the anode and the cathode.
12. The method of item 7, further including subjecting the metal recovery solution to ion exchange filtration and pH adjustment before discharge into the environment.
13. The method of item 1, wherein the recovering of the silver includes electrowinning the silver.
14. The method of item 13, wherein the electrowinning of the silver includes passing the metal recovery solution through an electrowinning cell including an anode and a cathode.
15. The method of item 14, including applying a voltage of between about 0.7 volts and about 1.2 volts across the anode and the cathode to deposit the silver from the metal recovery solution at the cathode.
16. The method of item 15, including electrowinning copper from the metal recovery solution after electrowinning the silver.
17. The method of item 16, wherein the electrowinning of the copper includes applying a voltage of about 1.2 volts and about 2.0 volts across the anode and the cathode to deposit copper from the metal recovery solution at the cathode.
18. The method of item 17, including using carbon electrodes for the anode and the cathode.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “an electrowinning cell”, as used herein, may also refer to, and encompass, a plurality of electrowinning cells.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the method of this disclosure has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A method of recycling solar panels, including silicon wafers, comprising:
delaminating the solar panel by breaking down ethylene-vinyl acetate polymer in the solar panel to generate fumed acetic acid;
dissolving silver from the silicon wafers of the solar panel in a metal recovery solution using the fumed acetic acid generated during the delaminating; and
recovering the dissolved silver from the metal recovery solution.

2. The method of claim 1, further including adding hydrogen peroxide to the fumed acetic acid to catalyze the dissolving of the silver.

3. The method of claim 2, including using about 25 wt % to about 75 wt % acetic acid mixed with about 15 wt % hydrogen peroxide to selectively dissolve the silver in the silicon wafers.

4. The method of claim 1, wherein the recovering of the silver includes electrowinning the silver.

5. The method of claim 4, wherein the electrowinning of the silver includes passing the metal recovery solution through an electrowinning cell including an anode and a cathode.

6. The method of claim 5, including applying a voltage of between about 0.7 volts and about 1.2 volts across the anode and the cathode to deposit the silver from the metal recovery solution at the cathode.

7. The method of claim 6, including electrowinning copper from the metal recovery solution after electrowinning the silver.

8. The method of claim 7 wherein the electrowinning of the copper includes applying a voltage of about 1.2 volts and about 2.0 volts across the anode and the cathode to deposit copper from the metal recovery solution at the cathode.

9. The method of claim 7, including changing the cathode before the electrowinning of the copper.

10. The method of claim 9, including using carbon electrodes for the anode and the cathode.

11. The method of claim 5, including using carbon electrodes for the anode and the cathode.

12. The method of claim 7, further including subjecting the metal recovery solution to ion exchange filtration and pH adjustment before discharge into the environment.

13. The method of claim 1, wherein the recovering of the silver includes electrowinning the silver.

14. The method of claim 13, wherein the electrowinning of the silver includes passing the metal recovery solution through an electrowinning cell including an anode and a cathode.

15. The method of claim 14, including applying a voltage of between about 0.7 volts and about 1.2 volts across the anode and the cathode to deposit the silver from the metal recovery solution at the cathode.

16. The method of claim 15, including electrowinning copper from the metal recovery solution after electrowinning the silver.

17. The method of claim 16, wherein the electrowinning of the copper includes applying a voltage of about 1.2 volts and about 2.0 volts across the anode and the cathode to deposit copper from the metal recovery solution at the cathode.

18. The method of claim 17, including using carbon electrodes for the anode and the cathode.
